(19) United States
(12) Patent Application Publication
(10) Pub. No.: US 2006/0021916 A1
(43) Pub. Date: Feb. 2, 2006

(54) Method for the flotation of contaminants from an aqueous fibrous suspension

(75) Inventors: Harald Hess, Gruenkraut (DE); Axel Dreyer, Ravensburg (DE); Martin Kemper, Weingarten (DE); Herbert Britz, Weingarten (DE); Anton Selbherr, Radolfzell (DE); Dietrich Moeller, Ebersbach (DE)

Correspondence Address: GREENBLUM & BERNSTEIN, P.L.C., 1950 ROLAND CLARKE PLACE, RESTON, VA, 20191, US

(73) Assignee: Voith Paper Patent GmbH, Heidenheim (DE)

(21) Appl. No.: 11/172,821

(22) Filed: Jul. 5, 2005

(30) Foreign Application Priority Data
Jul. 6, 2004 (DE) 10 2004 032 601.0

(51) Int. Cl. B03D 1/14

(52) U.S. Cl. 209/164

(57) ABSTRACT

Method and flotation vessel for removing contaminants from aqueous fibrous suspension. Method includes damming up fibrous suspension at head level above base of flotation vessel, forming a bubble flow of gas bubbles rising counter to field of gravity in dammed up fibrous suspension, and guiding fibrous suspension crosswise to bubble flow, such that as contaminants are deposited on gas bubbles to form thickened flotation foam, fibrous suspension is cleaned. Method also includes discharging cleaned fibrous suspension as accepts, and discharging thickened flotation foam. A flow cross section of flotation vessel lying crosswise to bubble flow is straight on at least 80% of at least one side wall and a length of side wall is at least 1.5 times as great as that of an end wall. This abstract is neither intended to define invention disclosed in this specification nor intended to limit the scope of the invention in any way.

### CROSS-REFERENCE TO RELATED APPLICATIONS

The present application claims priority under 35 U.S.C. §119 of German Patent Application No. 10 2004 032 601.0, filed on Jul. 6, 2004, the disclosure of which is expressly incorporated by reference herein in its entirety.

### BACKGROUND OF THE INVENTION

1. Field of the Invention

The invention relates to a method for the flotation of contaminants from an aqueous fibrous suspension using an upright flotation vessel, in which the fibrous suspension is dammed up at a head level-above a base of the flotation vessel. With the aid of gas bubbles, a bubble flow rising counter to the field of gravity is formed in the dammed up fibrous suspension. The fibrous suspension is guided crosswise to the bubble flow and is discharged in cleaned form as accepts, whereas contaminants are deposited on the gas bubbles and subsequently discharged together with the gas bubbles in a thickened flotation foam.

2. Discussion of Background Information

Methods of the above-mentioned type are used to separate at least part of the suspended contaminant particles out of an aqueous fibrous suspension. As is known, a foam or floating sludge containing the materials to be separated out is formed with flotation. A typical application of such a method is the treatment of an aqueous fibrous suspension obtained from printed recovered paper in which the printing ink particles are already released from fibers so that they can be floated off.

The flotation process described here utilizes the differences between pulp and undesirable solid particles in that the pulp remains in the fibrous suspension on account of its hydrophilic nature, while the targeted solid particles are hydrophobic and hence move into the foam together with the air bubbles. In addition to the printing ink particles, there is also a multitude of other substances that are hydrophobic and thus can be separated from the pulp through flotation. In particular, such materials are adhesives, fine synthetic material particles and perhaps also resins.

When fibers are to be separated from impurities through the flotation process, but not all solid particles are to be removed, it is called “selective flotation.” The term “flotation de-inking,” which is also used, is normally used not only for the removal of printing ink particles (ink=printing ink), but also more generally for the selective flotation of impurities out of fibrous suspensions.

The prior art with regard to flotation methods for fibrous suspensions is already very advanced. Therefore, there are solutions that are entirely appropriate for removing a large part of the solid particles through flotation. Since flotation systems are relatively expensive to purchase and operate, it is an understandable goal to improve their effectiveness or to reduce the expense necessary for achieving the same result.

The course of ongoing development of methods and apparatuses for the flotation of fibrous suspensions, particularly the movement of suspension and air bubbles in the flotation vessel, has been varied. The flow principle considered here is the cross-flow movement, i.e., the fibrous suspension is hydraulically guided essentially crosswise to the direction of flow of the air bubbles rising counter to the field of gravity. In the most common case by far, in which the driving force of the flotation is the earth's gravitation, this thus means that the air bubbles rise upward, and the fibrous suspension is guided essentially horizontally.

Methods of this nature are already widely used in industry, i.e., in the stock preparation required for papermaking, plants are operated that use this method and must process large production quantities. The expected, and today also possible, optimal effect of such methods depends critically on the flow rates that arise in the flotation vessels used. As a result, vessel volumes, cross sections, piping, etc. has to be matched to the desired production quantity in new facilities. When this matching succeeds without technological disadvantages, the effect is indeed assured, but higher costs arise due to constant new designs and changes in the fabrication of such devices.

### SUMMARY OF THE INVENTION

The present invention improves flotation methods of the above-mentioned type, such that it should be possible to optimize the cleaning result and/or yield of the process as easily as possible, even for differing production quantities.

Accordingly, the present invention is directed to a method for removing contaminants from an aqueous fibrous suspension using an upright flotation vessel, in which the fibrous suspension is dammed up at a head level above the base of the flotation vessel. With the aid of gas bubbles, a bubble flow rising counter to the field of gravity is formed in the dammed up fibrous suspension. The fibrous suspension is guided crosswise to the bubble flow and is discharged in cleaned form as accepts, whereas contaminants are deposited on the gas bubbles and subsequently discharged together with the gas bubbles in a thickened flotation foam. The flow cross section of the flotation vessel lying crosswise to the bubble flow is straight on at least 80% of at least one side wall and a length of the side wall is at least 1.5 times as great as a width of an end wall. Moreover, the length is preferably at least twice as great as the width of the end wall.

Through the features described, it is possible to produce an even flow in the flotation vessel, since disruptive turbulences are largely avoided due to the length/width ratio chosen, and hence the flows of suspension and bubble flow can develop in optimal fashion. Moreover, the additional advantage is afforded that the entire flotation system is easily built from modules, i.e., individual flotation vessels. These modules are easily installed together at their side walls. In this embodiment of the method, the modules with which a flotation step (e.g., primary or secondary flotation) is to be performed are operated in parallel. For greater throughputs in one stage, correspondingly more modules are used, and for smaller throughputs, correspondingly fewer. New, expensive optimization attempts are then no longer necessary.

The method according to the invention can be applied to all known flotation vessel forms of the above-mentioned type. Thereby the fibrous suspension to be floated can be added, e.g., from the side into the liquid located in the flotation vessel where it encounters the rising bubble stream.

The present invention is directed to a method for removing contaminants from an aqueous fibrous suspension using an upright flotation vessel having side and end walls. The method includes damming up the fibrous suspension at a head level above a base of the flotation vessel, forming a bubble flow of gas bubbles rising counter to a field of gravity in the dammed up fibrous suspension, and guiding the fibrous suspension crosswise to the bubble flow, such that as contaminants are deposited on the gas bubbles to form a thickened flotation foam, the fibrous suspension is cleaned. The method also includes discharging the cleaned fibrous suspension as accepts, and discharging the thickened flotation foam. A flow cross section of the flotation vessel lying crosswise to the bubble flow is straight on at least 80% of at least one side wall and a length of the side wall is at least 1.5 times as great as that of the end wall.

In accordance with a feature of the present invention, the length of the side wall can be at least twice as great as that of the end wall. Moreover, the length of the sidewall may be at least three times greater than that of the end wall.

According to another feature of the instant invention, the flow cross section may be essentially rectangular.

According to still another feature of the invention, an hydraulic diameter of the flow cross section is not greater than 2.7 m.

Further, the fibrous suspension to be floated may be guided through the bubble flow on at least part of its way in the flotation vessel.

According to the invention, the fibrous suspension can be fed into the flotation vessel uniformly distributed over at least 80% of the flow cross section.

The method can use at least two flotation vessels of equal size which touch one another on their side walls and are connected in parallel. A flotation system can be used chiefly including flotation vessels of equal size. Further, the flotation vessels can be open in design at the touching side walls.

In accordance with another feature, the fibrous suspension to be floated can be added from the side into the rising bubble flow.

Moreover, the fibrous suspension to be floated can be added unaerated and the method can further include aerating the suspension at a position beneath where the unaerated fibrous suspension is added.

Further still, the fibrous suspension to be floated may be added aerated and the method may further include partially aerating the suspension at a position geodetically beneath where the aerated fibrous suspension is added.

According to the invention, a point at which the suspension is introduced into the flotation vessel may lie geodetically above a discharge for the accepts.

In accordance with a further feature of the invention, the quantity of air added can be adjustable.

In accordance with another feature of the invention, a branch flow of the flotation foam can be guided back into a feed of the flotation vessel. The branch flow may be regulated.

The invention is directed to a flotation vessel for removing contaminants from an aqueous fibrous suspension. The flotation vessel includes a fibrous suspension inlet positioned below a dammed up head level, a device forming a bubble flow of gas bubbles rising counter to a field of gravity, and an accepts outlet positioned so that the fibrous suspension is guided crosswise to the bubble flow, such that as contaminants are deposited on the gas bubbles to form a thickened flotation foam, the fibrous suspension is cleaned. At least one side wall defines a vessel length and at least one end wall defines a vessel width, such that a flow cross section of the flotation vessel lying crosswise to the bubble flow is straight on at least 80% of the at least one side wall, and the vessel length is at least 1.5 times as great as the vessel width.

In accordance with still yet another feature of the present invention, the flotation vessel can include a second fibrous suspension inlet, which is arranged below the fibrous suspension inlet and is coupled to the accepts outlet, a second a device forming a bubble flow of gas bubbles rising counter to a field of gravity, and a second accepts outlet positioned so that the fibrous suspension through the second fibrous suspension inlet is guided crosswise to and through the second bubble flow to further clean the fibrous suspension.

The present invention is directed to a method for removing contaminants from an aqueous fibrous suspension. The method includes inserting the fibrous suspension into a flotation vessel having at least one side wall defining a vessel length and at least one end wall defining a vessel width, such that the vessel length is at least 1.5 times as great as the vessel width, and the fibrous suspension is inserted through an inlet arranged below a head level of the fibrous suspension within the flotation vessel, forming a bubble flow of gas. bubbles rising counter to a field of gravity in the fibrous suspension, and guiding the fibrous suspension crosswise to and through the bubble flow, such that as contaminants are deposited on the gas bubbles to form a thickened flotation foam, the fibrous suspension is cleaned. The method also includes discharging the cleaned fibrous suspension as accepts, and discharging the thickened flotation foam.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 diagrammatically illustrates an execution of the method in accordance with the instant invention;

FIG. 2 illustrates a view of a flotation installation suitable for the method of the instant invention;

FIG. 3 illustrates an example connection of two module groups;

FIG. 4 illustrates a variant of the method according to the instant invention;

FIG. 5 illustrates an implementation of the method according to the instant invention with foam recirculation.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

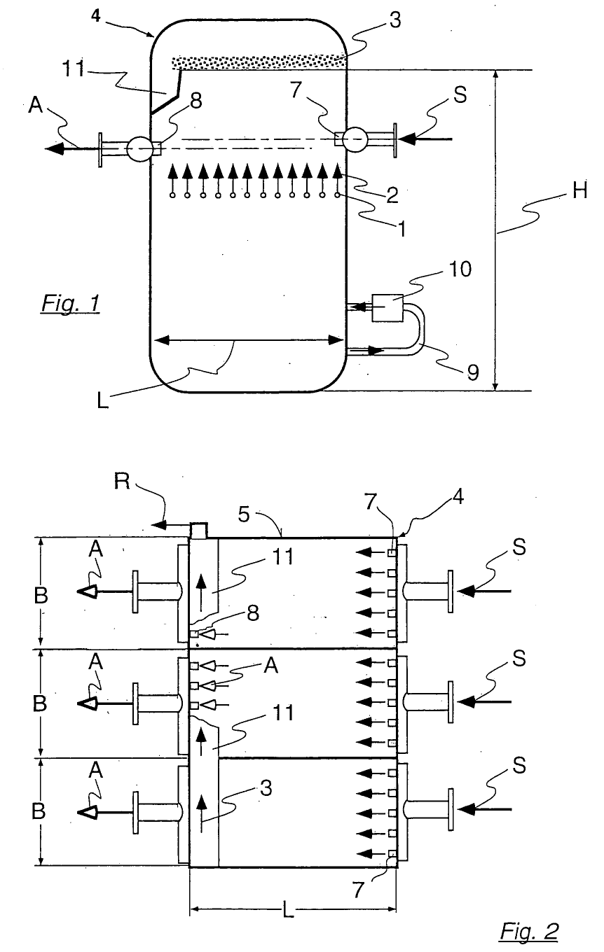

Flotation vessel 4 is shown in FIG. 1 in a sectional side view. Fibrous suspension S is added through at least one distribution opening 7 located at the top to the fibrous suspension already located in flotation vessel 4. Thereby, a uniform distribution seen across the width is particularly advantageous. Gas bubbles 1, of which only a few are drawn, form a bubble flow 2. Added fibrous suspension S is now guided crosswise to the ascending direction of the bubble flow 2 and in cleaned form as accepts A piped through at least one accepts outlet 8 out of flotation vessel 4. During this process, the flow cross section remains essentially the same. The contained contaminants are deposited on gas bubbles 1 in a manner known per se, and discharged upward in a thickened flotation foam 3. The foam is dammed up in the flotation vessel 4 at a foam gutter 11, which in general has an adjustable spillover weir, and discharged as reject R (see FIG. 2). The suspension in flotation vessel 4 beneath flotation foam 3 has head level H. In the example shown here, the gassing of the suspension is accomplished by a gassing circuit 9 whose function lies in drawing off part of the fibrous suspension, mixing it with gas in a gassing element 10, and then pumping it back into flotation vessel 4 at a somewhat lower point (it could also be a higher point).

Side wall 5 with length L and end wall 6 with width B are shown in FIG. 2, which depicts in diagrammatic form a total of three flotation vessels 4 in section and in a view from above. The ratio of length to width is an important feature to the practice of the invention, and should be at least 1.5, and preferably at least 2. Moreover, especially good flotation results can be achieved with a ratio of more than at least 3. The plurality of distribution openings 7 serves to distribute incoming fibrous suspension S evenly across the flow cross section. They are preferably equipped with holes, but can also be replaced by other distribution systems, e.g., with a wide slot. A uniform draining seen across the width is also advantageous with the accepts.

As is known, the hydraulic diameter for a given flow cross-section area can be varied by varying the length to width ratio. The hydraulic diameter is calculated according the formula: four times the cross-section area divided by the wetted circumference. It is greatest with circular cross sections and can be significantly reduced by varying the geometry and arrangement of the flotation vessel as described herein. The instant invention calms the suspension flow in the flotation vessel and improves the effectiveness of the method. Using the example of a flow cross-section area of 4 m², with a hitherto customary circular cross section the hydraulic diameter is approximately 2.3 m. If, in contrast, a rectangle with L=4 m and B=1 m is chosen, it is 1.6 m. If, for economic reasons, a larger flow cross-section area of 8 m² is chosen, the hydraulic diameter is 3.19 m for a circle and only 2.67 m for a rectangle with L=4 m and B=2 m.

In many cases a further advantage can be realized, since in addition to substantially improving the hydraulic conditions in flotation vessel 4, the embodiment of the flow cross section also produces a simple possibility for the modular construction of the entire flotation installation. As a result of the completely, or at least largely, straight side border of the flotation cell, modules can be installed next to one another in that they touch one another at the side walls. The problems of bulging that sometimes occur in angular containers then do not occur at the contact surfaces. It is not absolutely necessary for the walls to be solid between the modules, e.g., they can also have openings, e.g., in the bottom area of flotation vessel 4. They may also be missing altogether if a uniform flow arises in the modules without them.

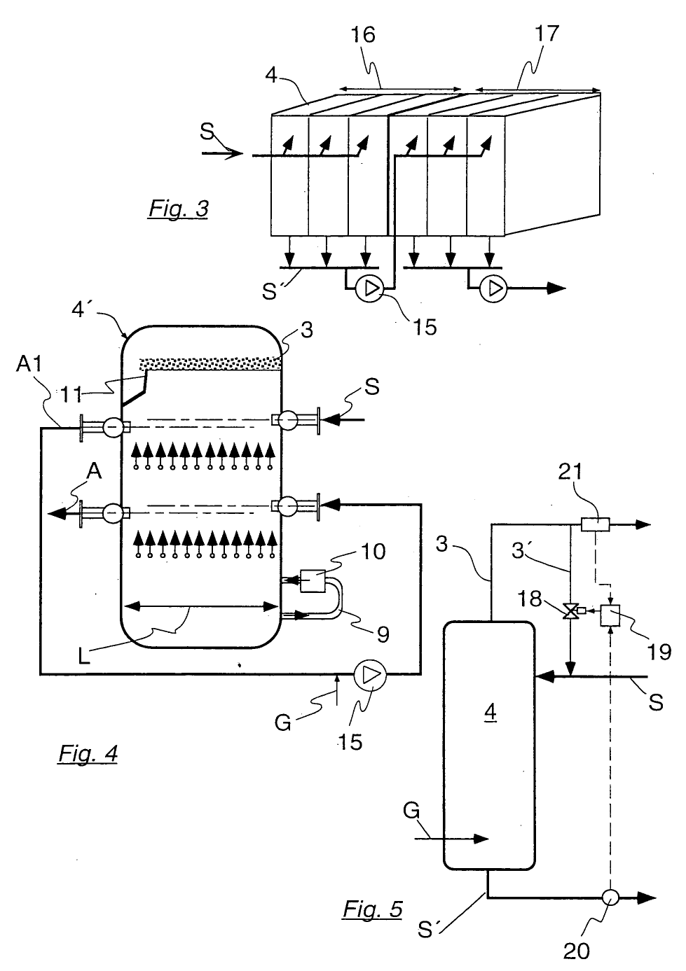

One possible mixture of parallel and series connections is shown in schematic form in FIG. 3. In accordance with this example, three modules of flotation vessels respectively are operated in parallel, i.e., in first group 16, three flotation cells are supplied with same fibrous suspension S. Accepts A from these three modules formed through flotation are combined and fed as a suspension S′ to second group 17 of again three modules by a pump 15. Pump 15 can also be used here for renewed gassing of accepts A (suspension S′). The advantages of the invention also apply to such systems. The method shown in FIG. 3 is thereby to be understood merely as an example, and it would also be possible to use, e.g., a single system composed of modules in two-stage operation in which the reject (foam) of the first stage is conveyed into the feed of the second stage.

As shown in FIG. 4, it is also possible to carry out the cross flow hitherto described in a flotation vessel 4′ several times above one another. Expediently, suspension S to be floated is added in the upper area of flotation vessel 4′. First accepted stock A1 formed in the cross flow is drawn off from flotation vessel 4′ and arrives, e.g., via a pump 15, back in flotation vessel 4′ as suspension S′. In pump 15, first accepted stock A1 (suspension S′) can be aerated again through additions of gas G. The addition point of suspension S′ thus formed is thereby advantageously geodetically below the point at which fibrous suspension S is introduced. In this manner, a counter-flow is generated in flotation vessel 4′ considered as a whole, which has the advantage that the “dirtiest” suspension comes into contact with the already heavily loaded air bubbles and becomes increasingly cleaner on the way downward, whereby the air bubbles then encountered also carry less dirt. With this counter-current principle, it is important that the speeds are optimally coordinated with one another in order to obtain the best flotation effect possible. Even if here the return of already floated accepts is shown only once, it can definitely take place several times.

A simple example of counter-current flotation is shown in FIG. 4 of the technical paper “Neue Systembausteine zur Aufbereitung von Altpapier: Entwicklung und Betriebserfahrungen,” J. Kleuser and T. H. Egenes, Wochenblatt für Papierfabrikation, 14/15, 1996. There, the stock feed takes place in the upper third of a round flotation apparatus, while gassing takes place in the lower part directly above the accepts discharge lying below. The foam is collected in the uppermost part of the flotation column and carried off. Another possibility is known, e.g., from DE 198 23 053. There the addition of the fibrous suspension occurs in the already formed foam. Here, too, air bubbles and suspension are moved in counter-current.

In many cases, the method is carried out such that only a single pass through a flotation vessel occurs in a stage. Then multiple flotation vessels of a flotation stage are not connected in series, but rather in parallel, so that flotation foam 3 produced has virtually the same quality throughout. A branch flow 3′ of this foam can advantageously be recirculated in the feed to flotation vessel 4, which is shown schematically in FIG. 5 (side view). In this process, the non-recirculated flotation foam thickens, which considerably simplifies the reject treatment and disposal. The size of recirculated branch flow 3′ can be adjusted for optimizing the process such that the loss of stock is minimal with the required quality. To this end, the signal (e.g., the degree of brightness) from a quality sensor 20 in outflowing accepts S′ is transmitted to a controller 19, which modifies branch flow 3′ via a control valve 18. An alternative to this arrangement is, e.g., regulating the foam quantity with the aid of a flowmeter 21, combined with measurement of the foam consistency, in which control valve 18 is activated in turn.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A method for removing contaminants from an aqueous fibrous suspension using an upright flotation vessel having side and end walls, comprising:
damming up the fibrous suspension at a head level above a base of the flotation vessel;
forming a bubble flow of gas bubbles rising counter to a field of gravity in the dammed up fibrous suspension;
guiding the fibrous suspension crosswise to the bubble flow, such that as contaminants are deposited on the gas bubbles to form a thickened flotation foam, the fibrous suspension is cleaned;
discharging the cleaned fibrous suspension as accepts;
discharging the thickened flotation foam,
wherein a flow cross section of the flotation vessel lying crosswise to the bubble flow is straight on at least 80% of at least one side wall and a length of the side wall is at least 1.5 times as great as that of the end wall.

2. The method in accordance with claim 1, wherein the length of the side wall is at least twice as great as that of the end wall.

3. The method in accordance with claim 1, wherein the length of the sidewall is at least three times greater than that of the end wall.

4. The method in accordance with claim 1, wherein the flow cross section is essentially rectangular.

5. The method in accordance with claim 1, wherein the hydraulic diameter of the flow cross section is not greater than 2.7 m.

6. The method in accordance with claim 1, wherein the fibrous suspension to be floated is guided through the bubble flow on at least part of its way in the flotation vessel.

7. The method in accordance with claim 1, wherein the fibrous suspension is fed into the flotation vessel uniformly distributed over at least 80% of the flow cross section.

8. The method in accordance with claim 1, wherein the method uses at least two flotation vessels of equal size which touch one another on their side walls and are connected in parallel.

9. The method in accordance with claim 8, wherein a flotation system is used chiefly comprising flotation vessels of equal size.

10. The method in accordance with claim 8, wherein the flotation vessels are open in design at the touching side walls.

11. The method in accordance with claim 1, wherein the fibrous suspension to be floated is added from the side into the rising bubble flow.

12. The method in accordance with claim 1, wherein the fibrous suspension to be floated is added unaerated and the method further comprises:
aerating the suspension at a position beneath where the unaerated fibrous suspension is added.

13. The method in accordance with claim 1, wherein the fibrous suspension to be floated is added aerated and the method further comprises:
partially aerating the suspension at a position geodetically beneath where the aerated fibrous suspension is added.

14. The method in accordance with claim 1, wherein a point at which the suspension is introduced into the flotation vessel lies geodetically above a discharge for the accepts.

15. The method in accordance with claim 1, wherein the quantity of air added is adjustable.

16. The method in accordance with claim 1, wherein a branch flow of the flotation foam is guided back into a feed of the flotation vessel.

17. The method in accordance with claim 16, wherein the branch flow is regulated.

18. A flotation vessel for removing contaminants from an aqueous fibrous suspension, comprising:
a fibrous suspension inlet positioned below a dammed up head level;
a device forming a bubble flow of gas bubbles rising counter to a field of gravity;
an accepts outlet positioned so that the fibrous suspension is guided crosswise to the bubble flow, such that as contaminants are deposited on the gas bubbles to form a thickened flotation foam, the fibrous suspension is cleaned; and
at least one side wall defining a vessel length and at least one end wall defining a vessel width, such that a flow cross section of the flotation vessel lying crosswise to the bubble flow is straight on at least 80% of said at least one side wall, and the vessel length is at least 1.5 times as great as the vessel width.

19. The flotation vessel in accordance with claim 18, further comprising:
a second fibrous suspension inlet, which is arranged below said fibrous suspension inlet and is coupled to said accepts outlet;
a second a device forming a bubble flow of gas bubbles rising counter to a field of gravity;
a second accepts outlet positioned so that the fibrous suspension through said second fibrous suspension inlet is guided crosswise to and through the second bubble flow to further clean the fibrous suspension.

20. A method for removing contaminants from an aqueous fibrous suspension, comprising:
inserting the fibrous suspension into a flotation vessel having at least one side wall defining a vessel length and at least one end wall defining a vessel width, such that the vessel length is at least 1.5 times as great as the vessel width, and the fibrous suspension is inserted through an inlet arranged below a head level of the fibrous suspension within the flotation vessel;
forming a bubble flow of gas bubbles rising counter to a field of gravity in the fibrous suspension;
guiding the fibrous suspension crosswise to and through the bubble flow, such that as contaminants are deposited on the gas bubbles to form a thickened flotation foam, the fibrous suspension is cleaned;
discharging the cleaned fibrous suspension as accepts; and
discharging the thickened flotation foam.
